(19) United States
(12) Patent Application Publication
(10) Pub. No.: US 2020/0126287 A1
(43) Pub. Date: Apr. 23, 2020

(54) SYSTEM AND METHOD FOR 3D INVENTORY CREATION AND MANAGEMENT

(71) Applicant: Capture XYZ, LLC, Seville, OH (US)

(72) Inventor: Alex Cherchian, Seville, OH (US)

(73) Assignee: Capture XYZ, LLC, Seville, OH (US)

(21) Appl. No.: 16/661,775

(22) Filed: Oct. 23, 2019

Related U.S. Application Data
(60) Provisional application No. 62/749,535, filed on Oct. 23, 2018.

(51) Int. Cl. G06T 15/10; G06T 19/00

(52) U.S. Cl. CPC G06T 15/10; G06T 2215/16; G06T 19/006

(57) ABSTRACT

A system and method for performing 3D documentation of a space, in particular the ability to create a 3D representation or model of a structure or object that is captured using a Terrestrial Laser Scanner for the purposes of inventory management, asset management, reality capture or property security.

### CROSS REFERENCE TO RELATED APPLICATION

This application is based on and claims priority to U.S. Provisional Patent Application No. 62/749,535 filed on Oct. 23, 2018, which is incorporated herein by reference in its entirety for all purposes.

### FIELD OF THE INVENTION

The present invention relates generally to the field of inventory management. More particularly, the present invention relates to a system and method for managing inventory using three-dimensional laser scanning.

### BACKGROUND

Three-dimensional laser scanning is a non-contact, non-destructive technology that digitally captures the shape of physical objects using a line of laser light. 3D laser scanners create “point clouds” of data from the surface of an object, allowing the scanner to capture a physical object's exact size, shape, and location relative to the scanner. 3D laser scanners measure fine details and capture free-form shapes, making them ideally suited to the measurement and inspection of contoured surfaces and complex geometries.

The 3D scanning process is not new and is used in a number of applications. The typical 3D scanning process involves placing a laser scanner in a position near the object to be measured. Next, the laser scanner projects a line of laser light onto the object while sensor cameras continuously record the changing distance and shape of the laser line in three dimensions as it sweeps across the object.

3D scanning has a wide variety of applications including, but not limited to: education, architecture, art/history, medicine/health, engineering, design, science/research, and virtual reality. Each of the aforementioned applications leverages the speed and precision of 3D laser scanners to enhance users' abilities to design, manufacture, learn, diagnose, and archive objects of many shapes and sizes.

3D scanners are not currently used for insurance inventory purposes. The homeowners and business insurance industry often relies on inventory information to satisfy claims. As such, it is valuable both to the home or business owner and to the insurance company to have an accurate, up-to-date inventory of the items in a home or business prior to damage that may occur. It is also valuable to have inventories of other locations such as schools, municipal buildings, or even public spaces for any purpose including Homeland Security. Current methods of taking inventories for insurance or other purposes typically include taking photographs of rooms and items and making notations of what is visible in the photos in a separate database or document. That process is time consuming and it is easy for people taking inventories in that way to miss things. Furthermore, conventional photos, which are typically used to create home and business inventories, are two-dimensional and do not provide a level of detail necessary to capture the items in each room or space. Finally, photographs are sometimes combined with a plan view of the room being inventoried, meaning that multiple documents must be used to create an accurate and useful inventory.

As such, there is a need for an inventory system and method that harnesses the precision, speed, and additional data offered by 3D laser scanning and applying it to the practice of taking home and business inventories.

### SUMMARY

The present invention relates to a system and method for obtaining an inventory of objects in at least one space. The method comprises the steps of identifying a space to be inventoried, evaluating the space to determine where to place a laser scanner, and placing a laser scanner in an optimal location within the space. Next, a user uses a laser scanner to scan the space, wherein the results of the scan are stored on the internal memory of the scanner to be transferred onto a computing device in the form of a dataset, wherein the computing device includes a microprocessor, a memory, and a display. Next, the results of the scan are displayed on the display as a three dimensional rendering. The next step involves identifying at least one asset in the dataset and virtually tagging (“geotagging”) the asset to assign identifying information to the asset. Finally a list of assets present in the space is generated and provided to a customer in an electronic report.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a flow diagram showing one embodiment of an inventory system and method in accordance with the invention;

FIG. 2 is a schematic view of a room being scanned by a three-dimensional laser scanner in accordance with the invention;

FIG. 3 is a schematic view of one embodiment of a scanner software user interface showing locations of scanner set ups in and around a school;

FIG. 4 is another schematic view of the scanner software user interface of FIG. 3 showing a three-dimensional point cloud of a room in a school with photos of the room draped over the point cloud;

FIG. 5 is another schematic view of the scanner software user interface of FIG. 3 showing locations of scanner set-ups in and around a school and further showing a quality report of the totality of the scans;

FIG. 6 is a schematic view of one embodiment of a software user interface showing a three-dimensional rendering of a space including geotags on various items within the rendering;

FIG. 7 is another schematic view of the scanner software user interface of FIG. 3 showing a three-dimensional point cloud of a gymnasium in a school with photos of the room draped over the point cloud and further showing dimensional analysis of the gymnasium;

FIG. 8 is a schematic view of one embodiment of an inventory report in accordance with the invention; and

FIG. 9 is another schematic view of the inventory report of FIG. 8, including a quality report of the totality of scans made to complete the inventory.

### DETAILED DESCRIPTION

The present invention relates to a system and method for documenting assets in a space using 3D modeling and reality capture techniques. In one example, the equipment used is a “Terrrestrial Laser Scanner” (“scanner 250”) which creates a detailed 3D rendering of a space and captures photos of the space simultaneously. The scanner 250 used in the embodiment shown in the Figures is a Leica BLK360 in conjunction with Leica Register 360 software. Of course, any other suitable laser scanner and software may alternatively be used without departing from the invention.

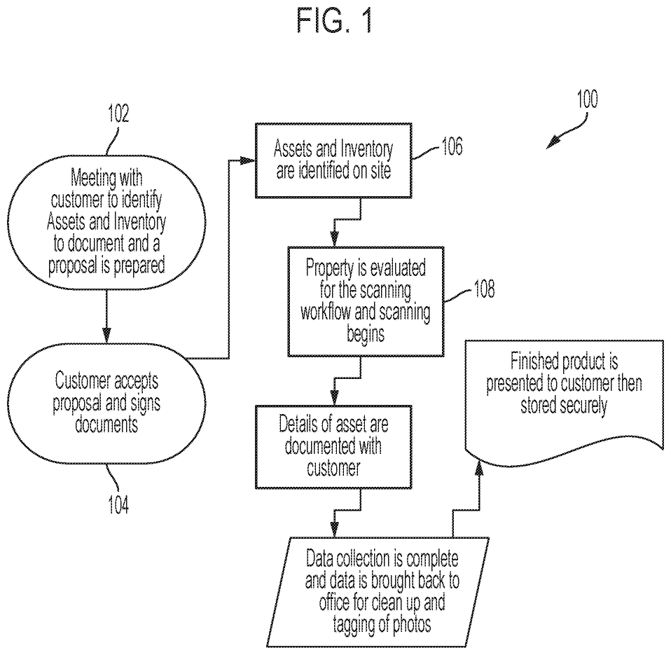

FIG. 1 is a flow chart showing the workflow 100, according to the invention, of scanning a space and obtaining an inventory for insurance or other purposes. Before the inventory scanning process begins, a consultation 102 with a potential customer takes place to identify important assets and other items to document and a proposal is prepared. To prepare a proposal, it is necessary to determine the scope of the project. The scope of an inventory project can vary greatly depending on the needs of the customer and the size of the space being scanned. The scope is determined by identifying assets and inventory onsite 106. For example, the scope of a project involving a residence would be much smaller than a project to create an inventory of a school or business location. Upon acceptance 104 of the proposal, the scanning process can begin.

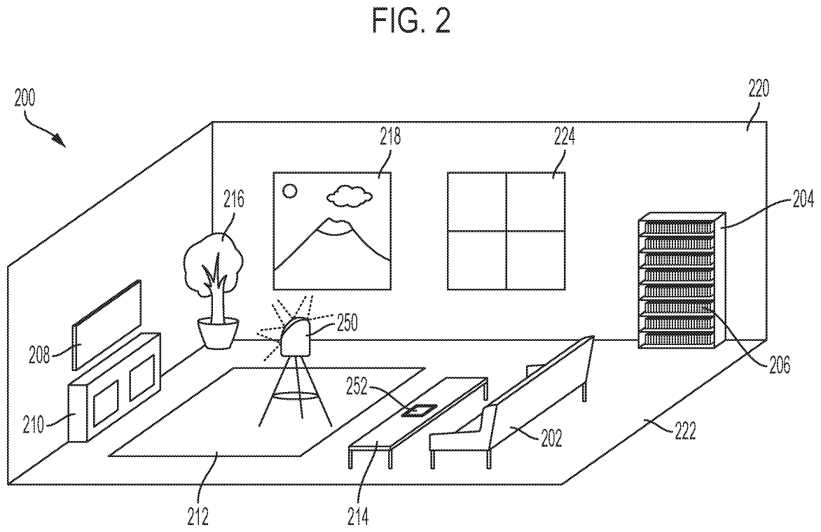

FIG. 2 is a schematic view of a typical room 200 to be scanned in accordance with the invention. The room 200 includes a variety of items such as a couch 202, a bookshelf 204, a plurality of books 206, a television, 208, a television cabinet 210, a rug 212, a coffee table 214, a plant 216, and a painting 218. In addition to the items in room 200, the walls 220 may be painted or covered in wallpaper or tile, the floor 222 may be carpeted, hardwood, or laminate, and the window 224 may be a variety of styles. When an insurance claim is processed, especially in the event of a disaster such as a fire or tornado, all of the aforementioned information is valuable to the insurer to it can accurately process a claim. It is also valuable to the insured because it ensures that all of its valuable assets are captured, even if they cannot remember all of the details of the assets after the disaster. To scan room 200, a scanner 250 is placed centrally in the room and is set to scan. The scanner 250 captures data in three steps: (1) taking pictures of the room, (2) scanning the room in three-dimensions, and (3) determining and identifying “common” objects between scans to “stitch” multiple scans together. In the embodiment shown, the scanner measures and captures an object or structure at 360,000 points per second while also collecting high definition photos to “drape” over the scan to show “true” color representations. Of course, other rates and density of point capture may be used without departing from the invention. The scanner 250 may be set up on a tripod and is used with some type of computing device 252, such as a tablet computer or iPad, which allows users to collect data and photos accurately. The computing device 252 includes rendering, modeling, and tagging software. In the present embodiment, the computing device 252 is a typical tablet computer, which includes a microprocessor, a memory, and a display, but any suitable computer may be used without departing from the invention. The laser scanner utilizes point cloud data collected by the scanner 250 and photos also collected by the scanner. Typically the accuracy of the data obtained by the laser scanner is >6 mm. The data obtained by the scanner 250 may be processed using software either embedded in the scanner, on the computing device 252, or hosted remotely, to create a full three-dimensional rendering of the object or asset being documented.

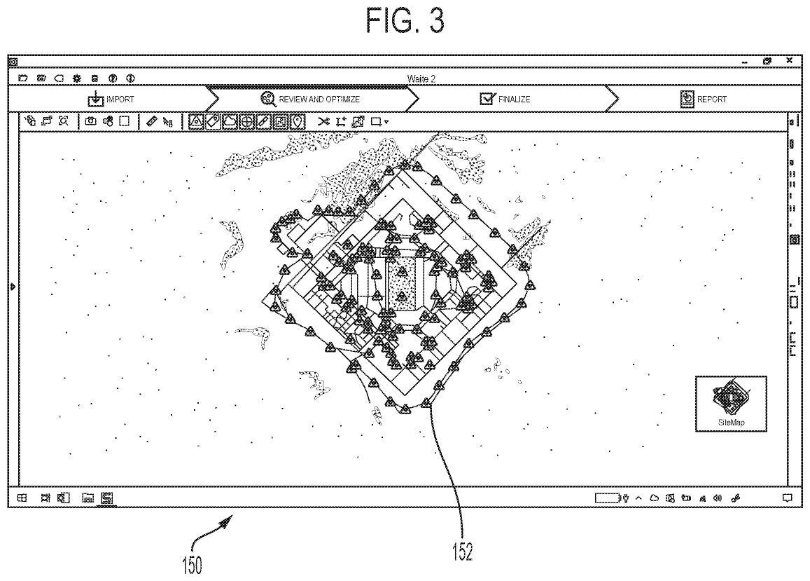

FIG. 3 is a diagram showing one example of how a scanner may be set up around a school 150 to generate an inventory. As shown, it is necessary to “traverse 108 (see FIG. 1)” the school 150 to properly to capture the desired data. Scanners 250 typically have a range of approximately one hundred feet, but are most accurate to approximately fifty feet. As a result, it is normal to move a scanner 250 roughly 30-50′ from set-up to set-up to ensure that there is sufficient overlap of the scan data to allow the software to accurately stitch the scans together. Each triangle 152 shown in FIG. 3 represents a location where scanner 250 would be set up to capture a complete scan of the school 150.

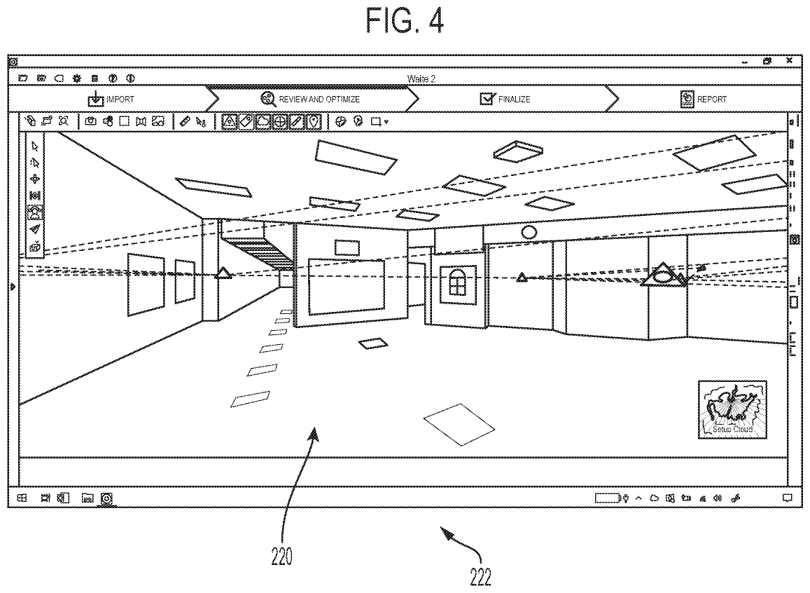

Turning now to FIG. 4, one example of a three-dimensional point cloud 220 with photos (not shown) draped over the point cloud is shown. As shown, by draping the photos captured by the laser scanner over the point cloud 220, a three-dimensional representation of the space 222 is produced. The image shown in FIG. 4 is an unprocessed image, but when the scanner software further processes the data, a much clearer image is generated.

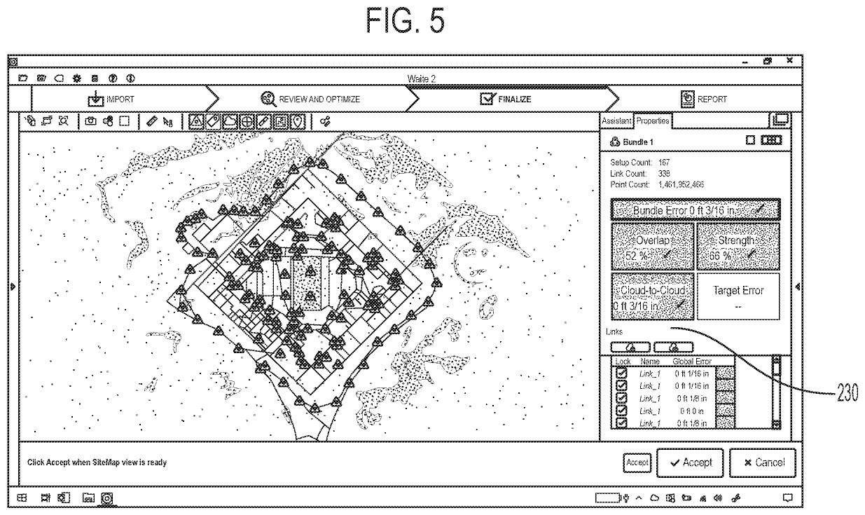

After a dataset is produced by completing scans of a space 222, the data is processed by software, which analyzes the data for inaccuracies and further pieces together data from multiple scans to generate a highly accurate three-dimensional representation of the space 222. Once the data 224 is processed, the software displays important information to the user including how many scans were processed and a measurement 230 of the accuracy of the three-dimensional point cloud 220. In typical scans, point accuracy is often better than 3/16″, but any suitable accuracy may be used without departing from the invention. FIG. 5 is a schematic showing one embodiment of a user interface of the scanning software, indicating the aforementioned measurements 230 related to the processed scans.

Once the data 224 is processed by the software, a user can begin geotagging items captured in the scans. Geotagging is defined by placing a virtual “marker” on an item (asset) and tagging it in the software to show additional information. In some embodiments, the system may be able to automatically detect and tag assets based on historical data or data from other sources, such as the internet or from manufacturers. For example, in some embodiments the system may be able to recognize a particular television hanging on a wall in a room based on images found online or from data supplied by a manufacturer.

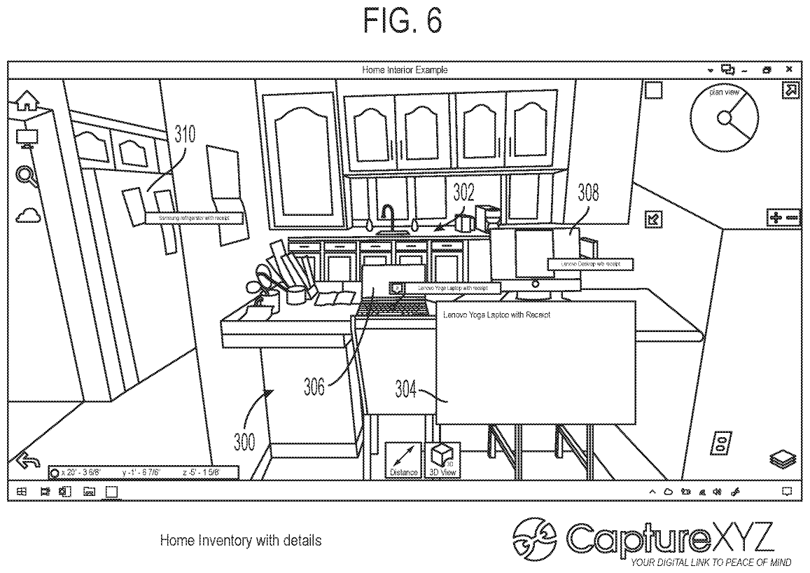

FIG. 6 is a schematic of one embodiment of a three-dimensional rendering of a space, including geotags 304, in accordance with the invention. As shown in FIG. 6, a dining area 300 and kitchen 302 are visible. The rendering was produced as described previously. To add geotags 304 to items, a user reviews the rendering and manually tags items. In alternative embodiments, the tagging process may be automated. Such automation may be achieved by creating a database of images from past scans, which software can compare against future scans. In the embodiment shown, each geotag 304 can include any desired information. As shown in FIG. 6, a laptop computer 306, desktop computer 308, and refrigerator 310 are geotagged 304. Each geotag 304 includes pertinent information about the item being tagged including make, model and/or serial number and, if available, documents such as a receipt of purchase 312. The user may select whatever information is available to include in each geotag 304 to suit the scope of the project. Placing a geotag 304 on each item allows a customer, whether a homeowner or insurer, not only to see what the asset is, but also its value for inventory purposes. In cases of disaster, theft, or other reasons, such information can be vital. Of course, the inventory can be done with as little or as much detail as is desired, as the case may be. For example, not only can major appliances and valuables be documented, but so can construction materials of a building such as the type of siding, paint color, window style, floor covering, lighting fixtures, plumbing fixtures, etc.

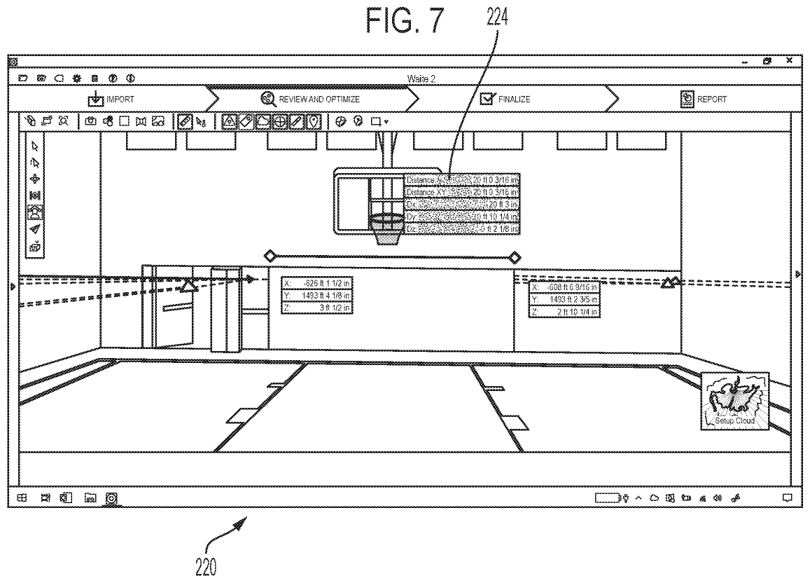

Additional data 224 about the space being scanned may also be stored for insurance or any other suitable purpose. Turning now to FIG. 7, a schematic of a three-dimensional point cloud 220 of a school gymnasium is shown. Such additional data 224 may include room size, window size and location, and any other details about the construction of the space that may be useful when processing an insurance claim. As shown, the detailed and highly accurate data obtained by scanner 250 allows dimensioning to be done from analyzing the three-dimensional rendering. In the case of a disaster, such dimensions are also valuable information to insurance companies.

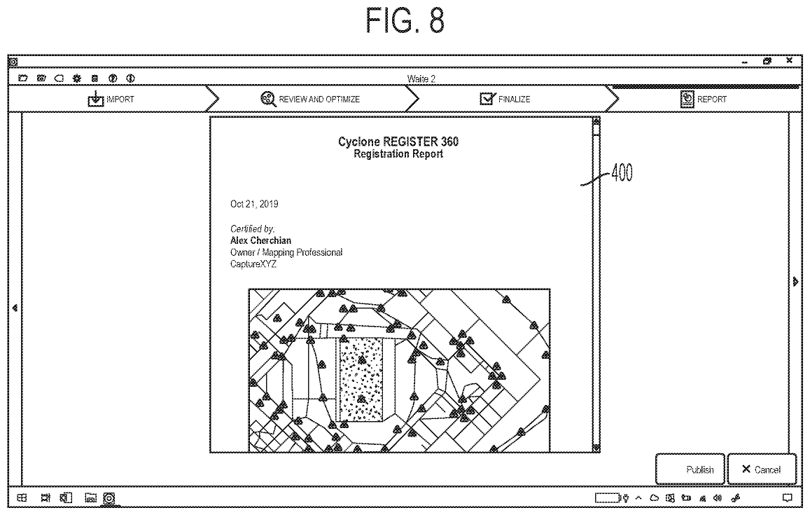

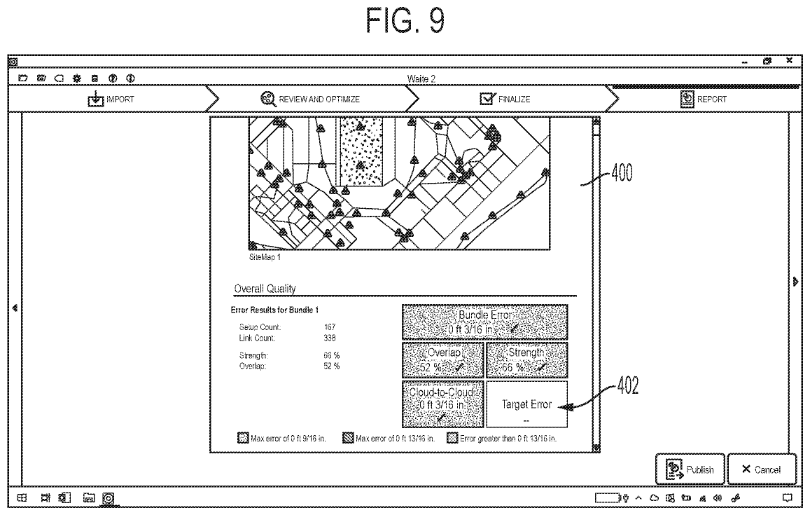

Turning now to FIGS. 8-9, once the data collection and geotagging tasks are complete, a report 400 is generated that is presented to the customer and may also be stored securely by the person responsible for taking the inventory. In the embodiment shown, the report includes a multitude of information including, but not limited to, three-dimensional renderings (not shown), a quality report 402, photos (not shown), and a listing of tagged items (not shown). In addition to the written report shown in FIGS. 8-9, an electronic version of the inventory data, including tags, is also created and supplied to the customer. The electronic version includes the full dataset and a three-dimensional rendering of the space that was inventoried, along with the ability to rotate and interact with the 3D view.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A method for obtaining an inventory of objects in at least one space, the method comprising the steps of:
identifying a space to be inventoried;
placing a laser scanner in at least one location within the space;
scanning the space, the results of the scan stored in a dataset on a computer, the computer having a microprocessor, a memory, and a display;
displaying the results of the scan on the display as a three dimensional rendering;
identifying at least one asset in the dataset; and
generating a list of assets present in the space.

2. The method of claim 1, further comprising the step of evaluating the space to determine where to place the laser scanner within the space.

3. The method of claim 2, further comprising the step of placing the scanner in an optimal location within the space.

4. The method of claim 1, wherein the results of the scan comprise a point cloud and at least one photograph.

5. The method of claim 4, wherein the at least one photograph is virtually draped over the point cloud to create a three-dimensional rendering of the space.

6. The method of claim 1, wherein assets are identified in the dataset by applying a geotag to the asset.

7. The method of claim 6, wherein the geotag assigns details related to the asset to which it is assigned.

8. A method for obtaining an inventory of objects in at least one space, the method comprising the steps of:
identifying a space to be inventoried;
placing a laser scanner in at least one location within the space;
scanning the space, the results of the scan stored in a dataset on a computer, the computer having a microprocessor, a memory, and a display;
displaying the results of the scan on the display as a three dimensional rendering;
identifying at least one asset in the dataset by applying a geotag to the asset, each geotag assigning details related to the asset to which it is assigned; and
generating a report of assets present in the space.

9. The method of claim 8 further comprising the step of evaluating the space to determine where to place the laser scanner within the space.

10. The method of claim 9, further comprising the step of placing the scanner in an optimal location within the space.

11. The method of claim 8, wherein the results of the scan comprise a point cloud and at least one photograph.

12. The method of claim 11, wherein the at least one photograph is virtually draped over the point cloud to create a three-dimensional rendering of the space.

13. A method for obtaining an inventory of objects in at least one space in connection with a computing device, the computing device having a microprocessor, a computer memory, and a display, the method comprising the steps of:
operating a 3D laser scanner to scan the space and create scan results,
storing the scan results in a dataset in the computer memory;
displaying the results of the scan on the display as a three dimensional rendering;
geotagging at least one asset in the dataset; and
generating a list of assets present in the space.

14. The method of claim 13, further comprising the step of evaluating the space to determine where to place the 3D laser scanner within the space.

15. The method of claim 14, further comprising the step of placing the 3D laser scanner in an optimal location within the space.

16. The method of claim 13, wherein the results of the scan comprise a point cloud and at least one photograph.

17. The method of claim 16, further comprising virtually draping the at least one photograph over the point cloud to create a three-dimensional rendering of the space.

18. The method of claim 13, wherein the geotagging step includes recording details related to the asset that is geotagged and associating those details with that asset.
